(19) United States
(12) Patent Application Publication
(10) Pub. No.: US 2016/0136499 A1
(43) Pub. Date: May 19, 2016

(54) CYCLING PRACTICING SYSTEM

(71) Applicant: Gabriel Hanoch Rothstein, Haifa (IL)

(72) Inventor: Gabriel Hanoch Rothstein, Haifa (IL)

(21) Appl. No.: 14/941,695

(22) Filed: Nov. 16, 2015

(30) Foreign Application Priority Data
Nov. 19, 2014 (IL) 235792

(51) Int. Cl. A63B 69/16; B62H 7/00

(52) U.S. Cl. CPC A63B 69/16; B62H 7/00

(57) ABSTRACT

A cycling practicing system, comprising: a guiding facility, comprising: a guiding track (20) fixed to the ground (26) or to a wall (38); and an elongated guided device (14), firmly connected via a pole (12) to a bicycle (10) of the trainee and adapted to allow horizontal deviation of approximately 3 degrees; wherein the guided device and the guiding track are loosely interlaced in each other and adapted to allow a vertical tilt of approximately 3 degrees; thereby providing stability for riding the bicycle and preventing it from falling down.

### TECHNICAL FIELD

The present invention relates to the field of cycling aid systems.

### BACKGROUND OF THE INVENTION

Learning to cycle is difficult for the student, as he must deal with balancing a two-wheeled vehicle, which by its nature is awkward and unbalanced. The difficulty increases with the age of the student. Furthermore, this obstacle is more acute for students with physical disabilities.

The most common solution to this problem is in the form of training wheels attached on the rear side of the bicycle. The training wheels give the bicycle a limited freedom to tilt. However, despite the support, the ability of the training wheels to completely prevent a fall of the cyclist is limited.

U.S. Pat. No. 5,577,750 discloses a bicycle stabilizing flex pole, attachable to the rear of a bicycle frame, adjacent its center of gravity. The trainer defines an elongated flexible tubular balancing pole having a free upper end, an intermediate section and a reinforced anchor engageable lower end with an adjustable pole anchor clamp and connector plate to secure the end of the pole to the frame of the bicycle.

The common disadvantage of the solutions presented above is the fact that the trainee needs to use a trainer for preventing the fall of the trainee upon losing balance. Additionally, the trainer has difficulty in catching up with the bike when the trainee travels at high speed.

All the methods described above have not yet provided a satisfactory solution to the problem of teaching the first steps of cycling without a trainer.

It is an object of the present invention to provide a solution to the above-mentioned and other problems of the prior art.

Other objects and advantages of the invention will become apparent as the description proceeds.

### SUMMARY OF THE INVENTION

A cycling practicing system, comprising: a guiding facility, comprising:
a guiding track (20) fixed to the ground (26) or to a wall (38); and
an elongated guided device (14), firmly connected via a pole (12) to a bicycle (10) of the trainee and adapted to allow horizontal deviation of approximately 3 degrees;
wherein the guided device and the guiding track are loosely interlaced in each other and adapted to allow a vertical tilt of approximately 3 degrees;
   thereby providing stability for riding the bicycle and preventing it from falling down.

Preferably, the guided device is elongated, thereby limiting a deviation of the bicycle.

According to one embodiment of the invention, the guiding track is in the form of a pair of parallel rails (20), and the guided device is in the form of a board (14) disposed between the parallel rails (20), the board being firmly connected by the pole (12) to the bicycle (10).

Preferably, the length of the board (14) is at least 10 cm, and the width of the board (14) is at least 10 cm.

According to another embodiment of the invention, the guiding track is in the form of a single rail or taut cable (24); and the guided device in the form of a profile surrounding rail or taut cable (24), and firmly connected by the pole (12) to the bicycle (10).

The profile may be in the form of a U profile, a V profile, an O profile, a square profile, a rectangular profile, two parallel boards, and so on.

Preferably, the length of the profile (16) is at least 10 cm, and the width of the profile (16) is also at least 10 cm.

According to yet another embodiment of the invention, the guided device is in the form of an inclined pole (12).

The guided device may further comprise a rigid or semi-rigid removable coating (30), for decreasing a space between the guided device and the guiding track, thereby increasing a limit of a tilt and deviation of the bicycle (10) with regard to the guiding track.

Preferably, the thickness of the removable coating is at least of 0.5 cm.

The pole (12) may be connected to a steering bar of the bicycle (10), to a bar connecting a seat of the bicycle with a steering of the bicycle (10), to a back of the bicycle (10), and so on.

Preferably, the space between the guided device and the guiding track is at least 2 cm.

The connection between pole (12) to the bicycle (10) may be carried out by an instant connector (18).

According to one embodiment of the invention, the guiding track (20, 24) is disposed above the head of a riding trainee (32).

According to another embodiment of the invention, the guiding track (20, 24) being disposed by a side of a said bicycle.

The pole (12) may be adapted to allow reversing the bicycle direction or employing an existing railing bar, by a detachable joint, rotatable joint, spherical joint, and so on.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIGS. 1 to 6 schematically illustrate a cycling practicing system, according to one embodiment (100) of the invention.

FIG. 1 is a front view of a cycling practicing system 100.

FIG. 2 is a side view thereof.

FIG. 3 is a side distant view thereof.

FIG. 4 is a front view of the cycling practicing system of FIG. 1, in a situation where the bicycle is tilted.

FIG. 5 is a zoomed view on a guided facility, according to this embodiment of the invention.

FIG. 6 is a perspective view that schematically illustrates a removable coating for the board.

FIG. 7 pictorially illustrates pole 12 when connected to the rear of bicycle 10.

FIG. 8 pictorially illustrates pole 12 connected to the steering bar of bicycle 10.

FIGS. 9 to 13 schematically illustrate a cycling practicing system, according to one embodiment (200) of the invention.

FIG. 9 is a front view of the system according to this embodiment of the invention.

FIG. 10 is a side view thereof.

FIG. 11 is a perspective zoomed view on an elongated profile 16.

FIG. 12 is a perspective zoomed view on the guided device which comprises a removable coating 30.

FIG. 13 is a front view of the system according to another configuration of this embodiment.

FIG. 14 schematically illustrates a cycling practicing system, according to a third embodiment (300) of the invention. Each of FIGS. 15 and 16 schematically illustrate a cycling practicing system 400, according to yet another embodiment of the invention.

FIG. 17 is a front-sectional view thereof.

FIG. 18 is a front-sectional view which schematically illustrates a cycling practicing system 500, according to yet another embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

### First Embodiment of the Invention

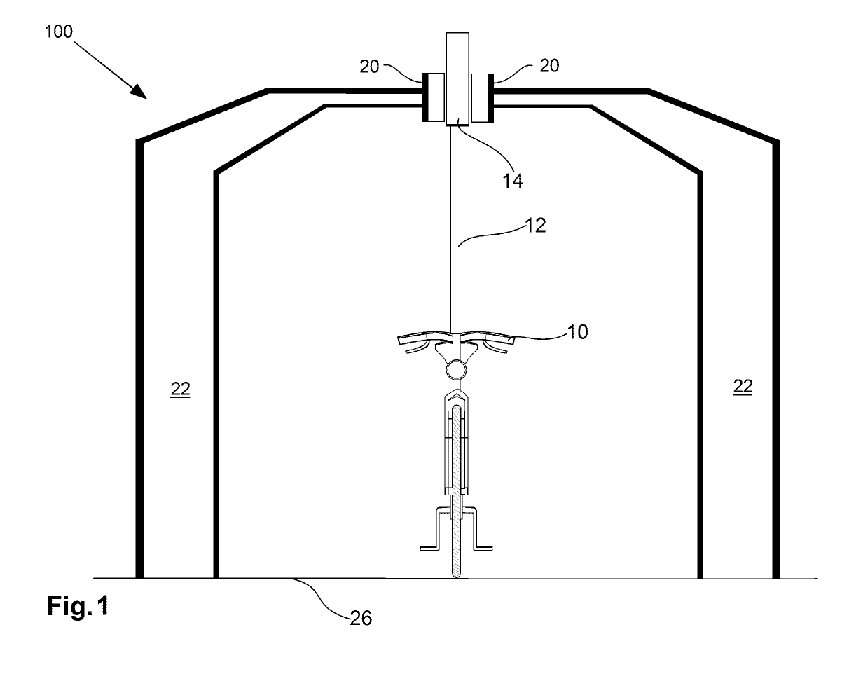

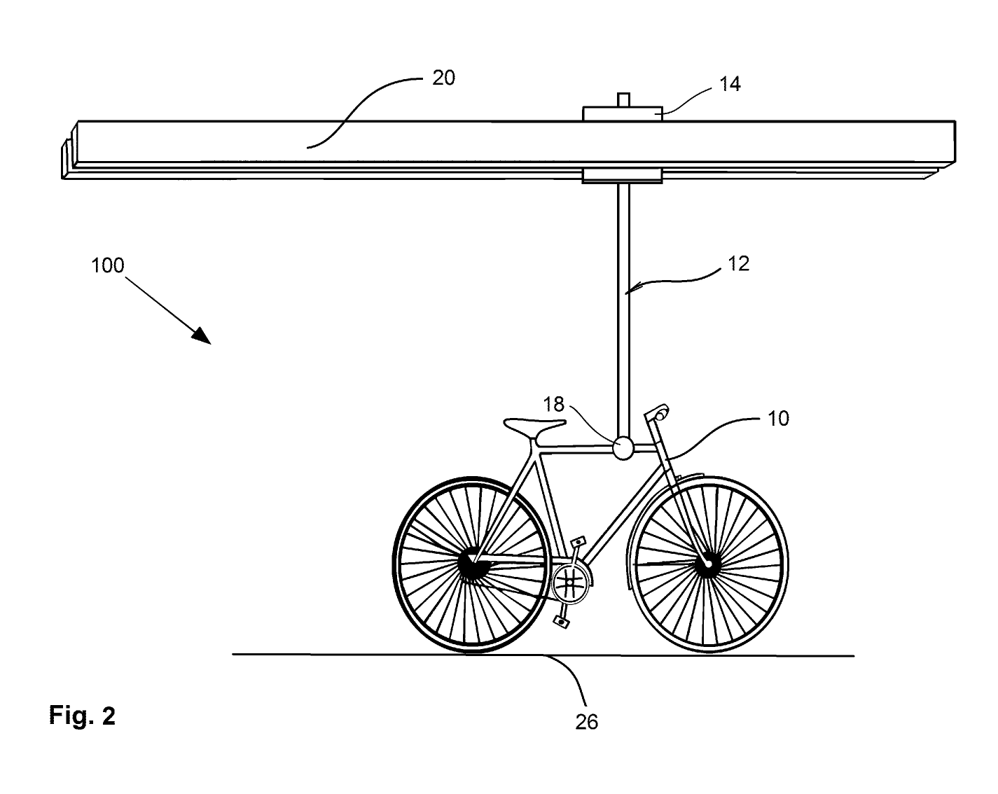

FIGS. 1 to 6 schematically illustrate a cycling practicing system, according to one embodiment (100) of the invention.

FIG. 1 is a front view of a cycling practicing system 100.

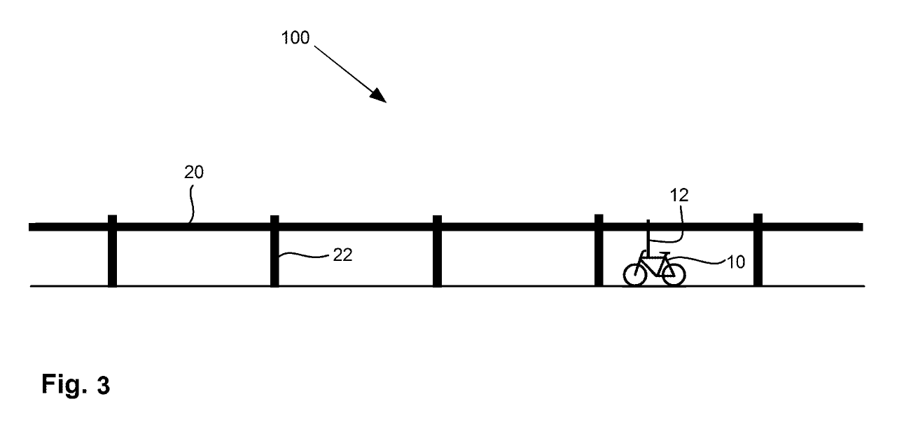

FIG. 2 is a side view thereof.

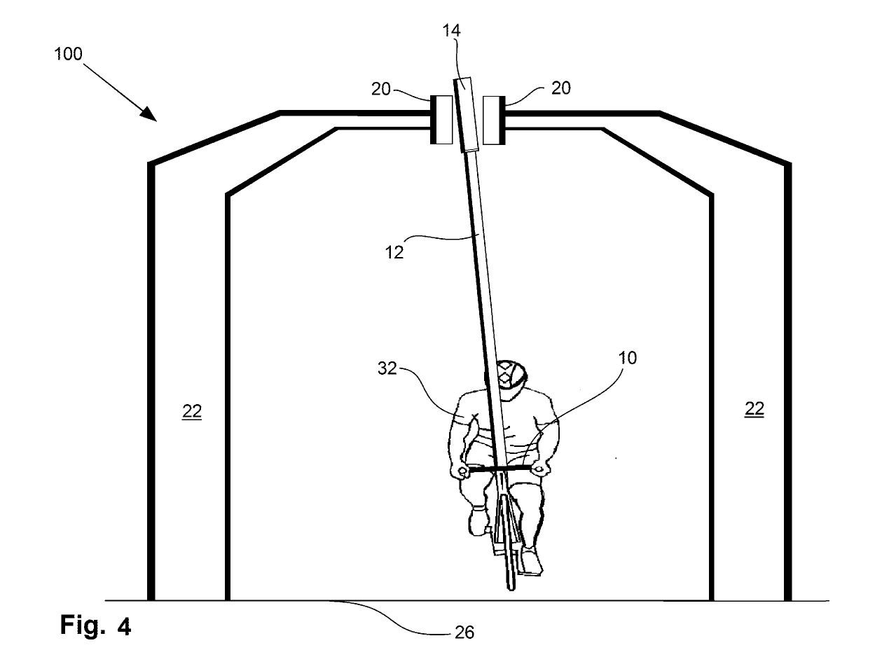

FIG. 3 is a side distant view thereof.

The system comprises two major parts: a guiding facility installed to the ground and a guided device attached to the bicycle of the trainee.

As per the guiding facility, it comprises a guiding track which according to this embodiment of the invention comprises a pair of parallel rigid guiding rails 20, connected to the ground by supporting pillars 22.

The rails are placed at least 50 cm above the head of the trainee, in parallel such that the flat surface of one rail turns towards the flat surface of the other.

Each of the guiding rails comprises a flat surface. The width (i.e., the distance between the bottom and the top) of each of the flat surfaces is at least 10 cm.

As per the bicycle 10 of the trainee, a guided device is attached thereto. According to this embodiment of the invention, the guided device comprises a rigid pole 12, a rigid board 14 which is firmly connected to one end of the pole, and an instant connector 18 firmly connected to the other end of the pole.

In use, the guided device is connected to the bicycle 10 of the trainee by the instant connector 18 such that the pole stands substantially vertical, and the board 14 is disposed between the rails 20.

The distance between the parallel rails 20 is as the width of the board 14 plus a few cm, e.g., 4 cm. As the width of the rails is at least 10 cm, the tilt of the bicycle is limited. Thus, even if the trainee loses his balance, he still cannot fall since the tilt of the bicycle is limited. Thus, a trainee can use the facility for cycling without the aid of a trainer.

An example of an instant connector 18 is the connector used to connect the seat of a racing bicycle to the chassis thereof.

FIG. 3 is a distant view of a cycling practicing facility, according to one embodiment of the invention.

The length of the facility may be from a few meters, to hundreds of meters, and even more.

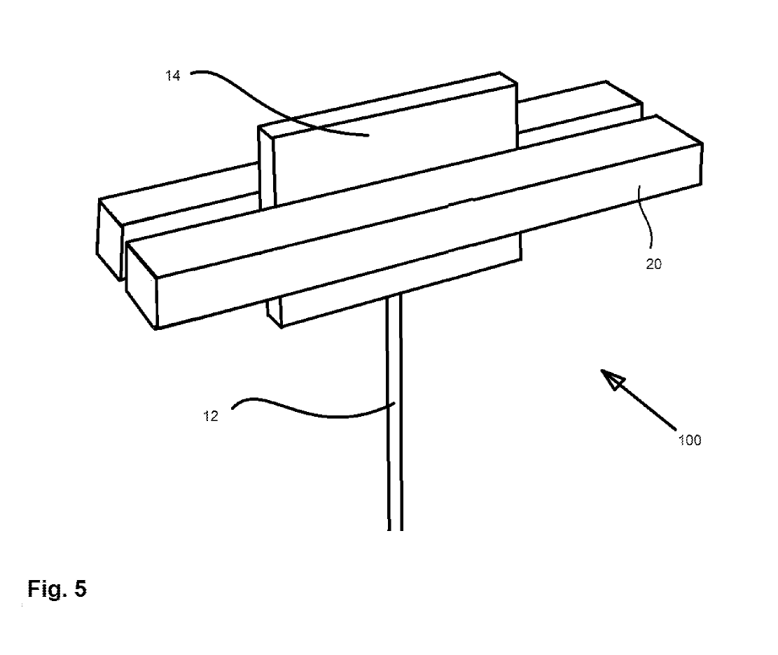

FIG. 4 is a front view of the cycling practicing system of FIG. 1, in a situation in which the bicycle is tilted.

In order to emphasize the tilt, in this figure the tilt is exaggerated.

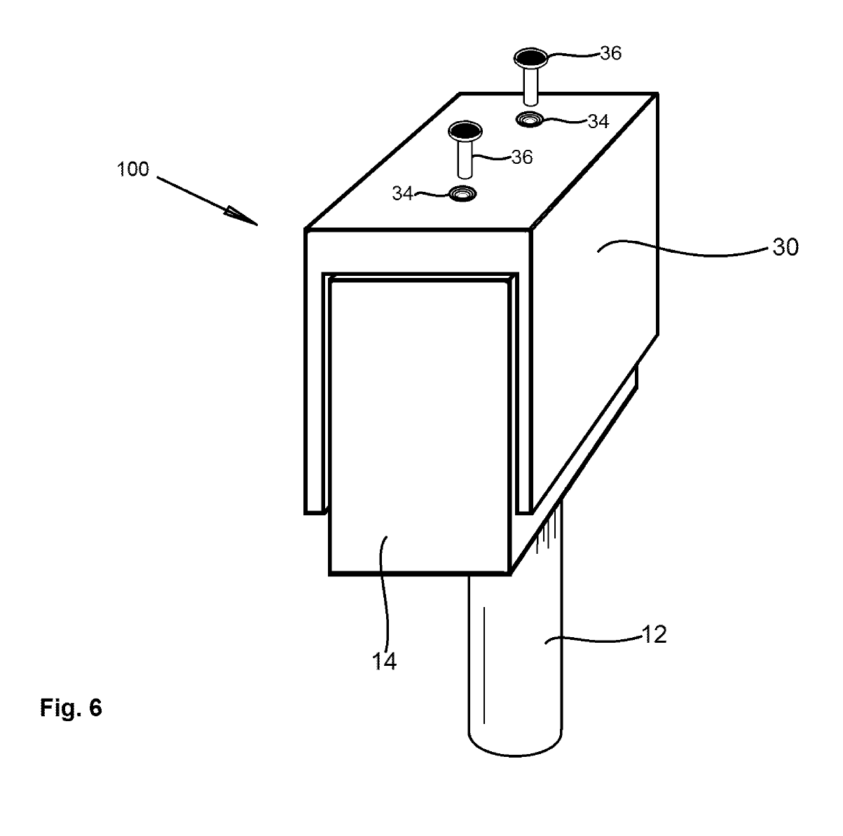

FIG. 5 is a zoomed view on a guided facility, according to this embodiment of the invention.

As mentioned, according to this embodiment of the invention, the guided device is in the form of a board 14.

The guided device accomplishes two objectives: limiting the tilt of the bicycle in order to prevent their fall, and limiting the bicycle from deviating from the lane determined by the rails.

The wider the board (i.e., the distance between the bottom and the top of the board), the smaller the tilt limit. The longer the board (i.e., the distance between the left and the right sides of the board), the smaller the deviation limit. However, a length of 10 cm and width of 10 cm may be adequate to provide the required guidance.

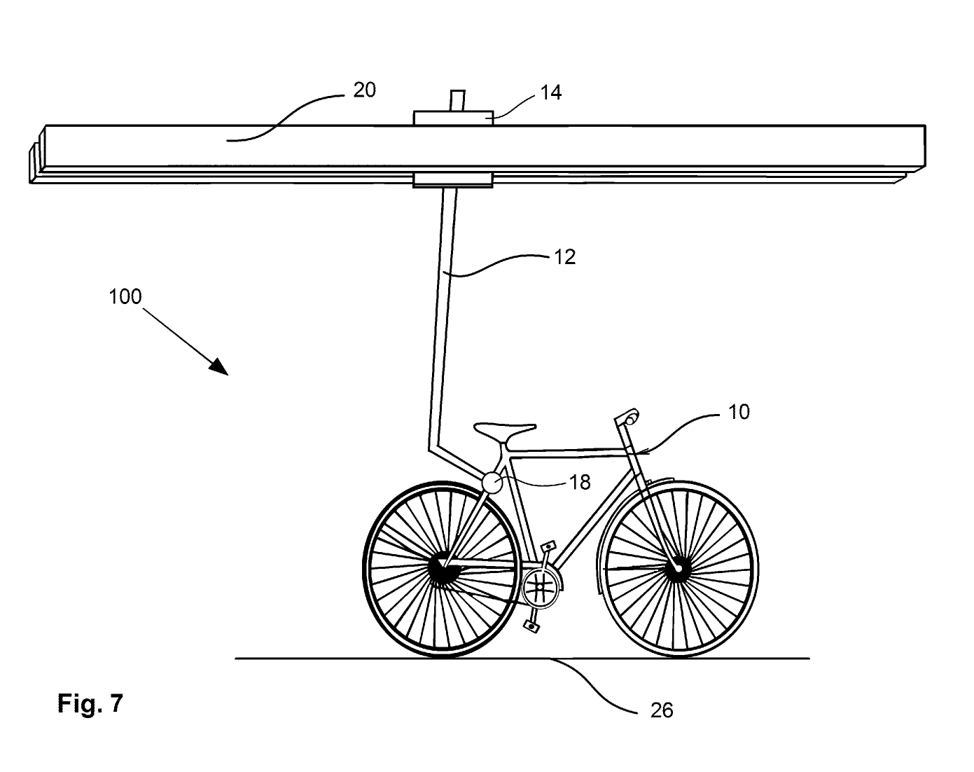

FIG. 6 is a perspective view that schematically illustrates a removable coating for the board.

In order to increase the tilting and the deviation limit, a removable coating 30 is placed on the board. The role of the removable coating is to decrease the free space between board 14 and the parallel rails 20. The wider the removable coating, the higher the tilt limits.

Numeral 34 denotes a bore in coating 30. Numeral 36 denotes a threaded bolt for securing coating 30 to the guided device. For carrying out the security, bolt 36 is threaded into the guided device (board 14 in this figure) through bore 34.

Removable coating 30 may be made of a rigid material, such as metal. The removable coating may also be made of semi-rigid material, in order to provide some softness to the contact between the elements that surround the removable coating, i.e., board 14 and the rails 20.

Removable coating 30 may comprise means for fastening thereof to the board, such as clips. Such means are not illustrated in the figures.

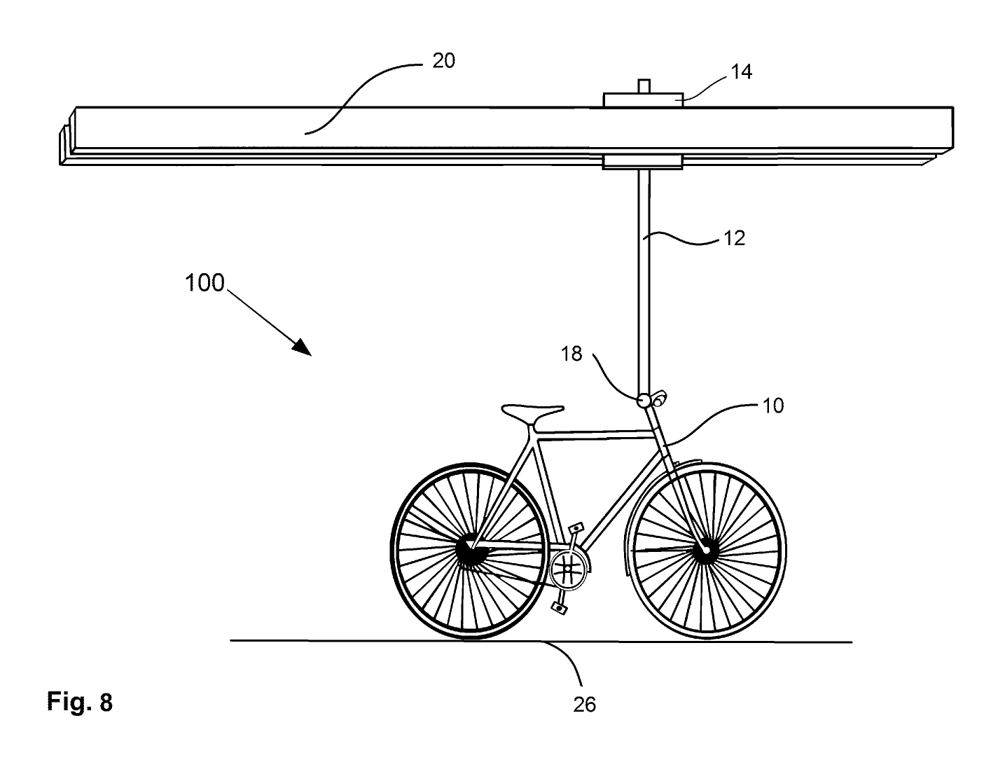

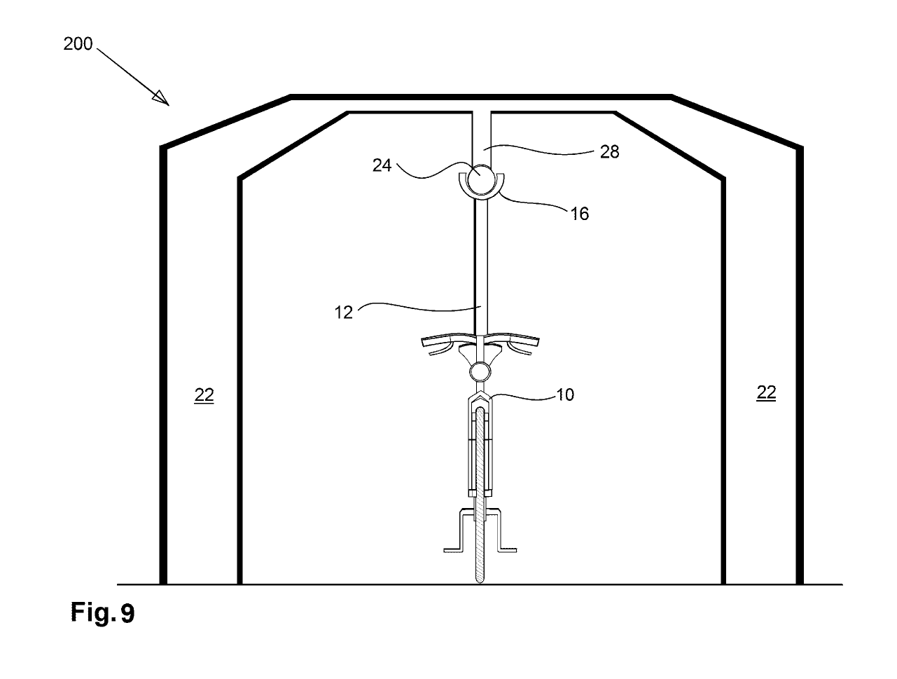

Each of FIGS. 2, 7 and 8 pictorially illustrates connecting pole 12 to a different object of bicycle 10 of the trainee: In FIG. 2, pole 12 is connected to the bar connecting the steering bar to the seat bar. In FIG. 7, pole 12 is connected to the rear of bicycle 10. In FIG. 8, pole 12 is connected to the steering bar of bicycle 10.

It should be noted that the guiding track can be fixed to a wall, as well as to the ground.

### Second Embodiment of the Invention

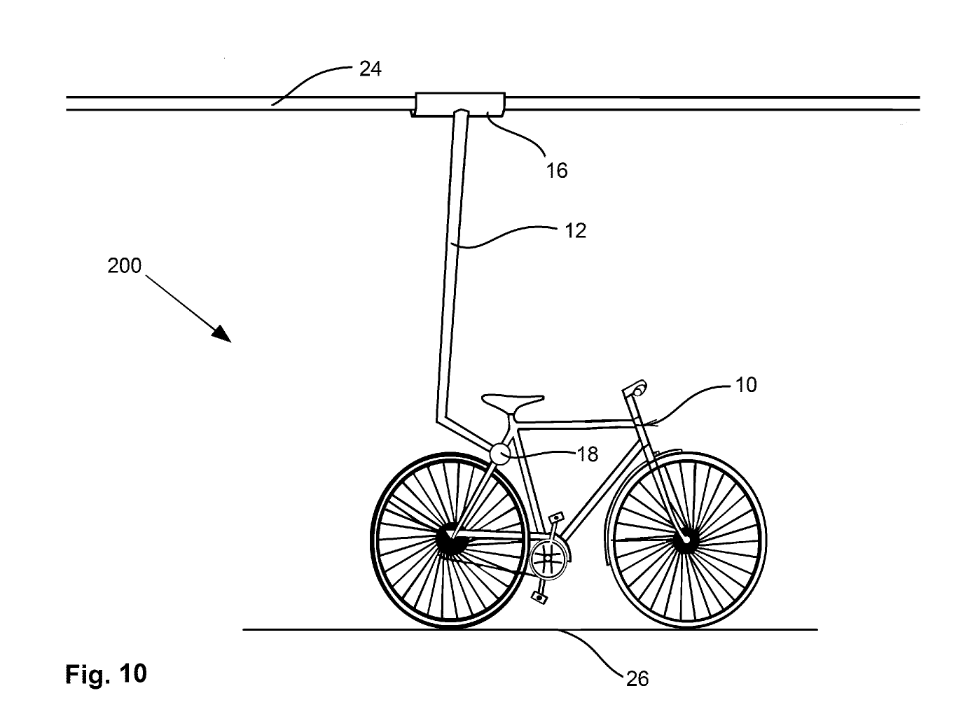

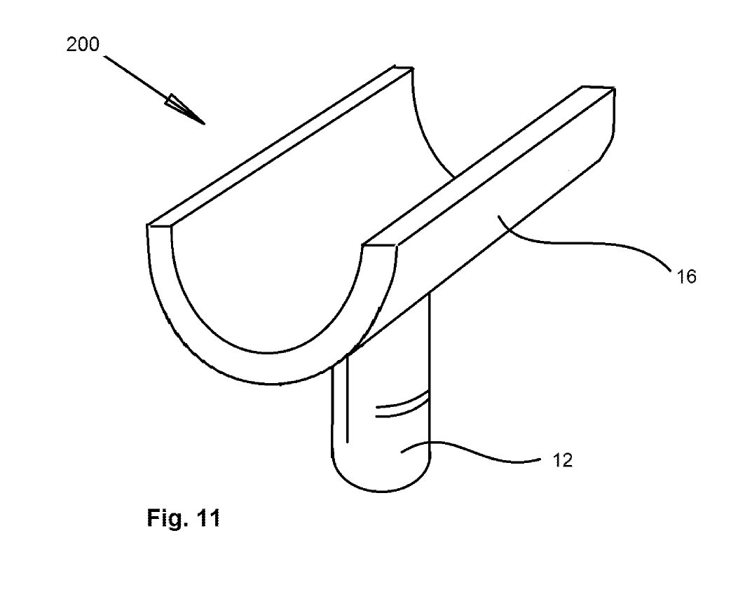

FIGS. 9 to 13 schematically illustrate a cycling practicing system, according to one embodiment (200) of the invention.

FIG. 9 is a front view of the system, according to this embodiment of the invention.

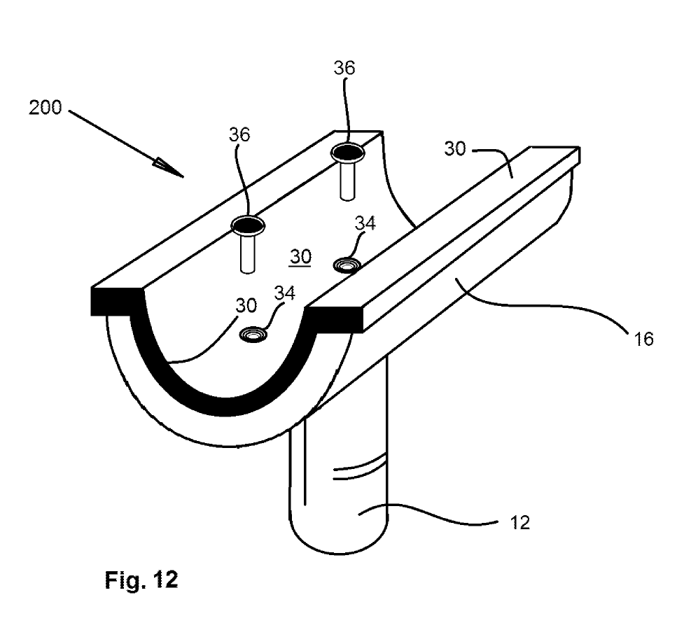

FIG. 10 is a side view thereof.

According to this embodiment of the invention, the guiding track of the guiding facility is in a form of a single rail or taut cable 24, while the guided device is in a form of an elongated profile 16 surrounding said single rail or taut cable 24.

The cross-section of profile 16 may be in the form of the letters U, V, O, a square, two parallel boards, and so on.

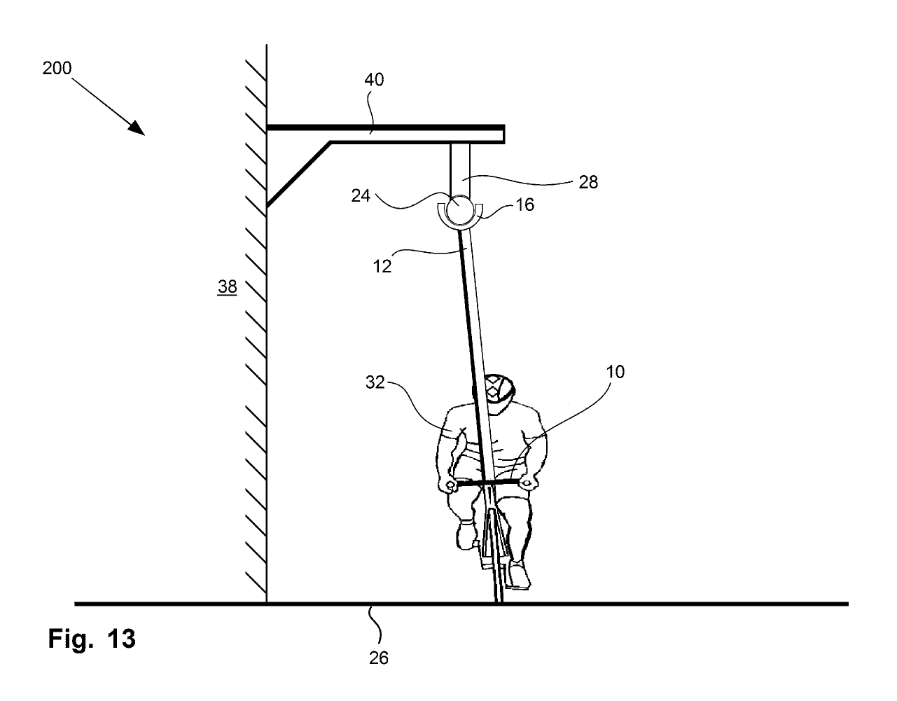

FIG. 11 is a perspective zoomed view on an elongated profile 16. According to this exemplary embodiment of the invention, the guided device is in the form of a U profile.

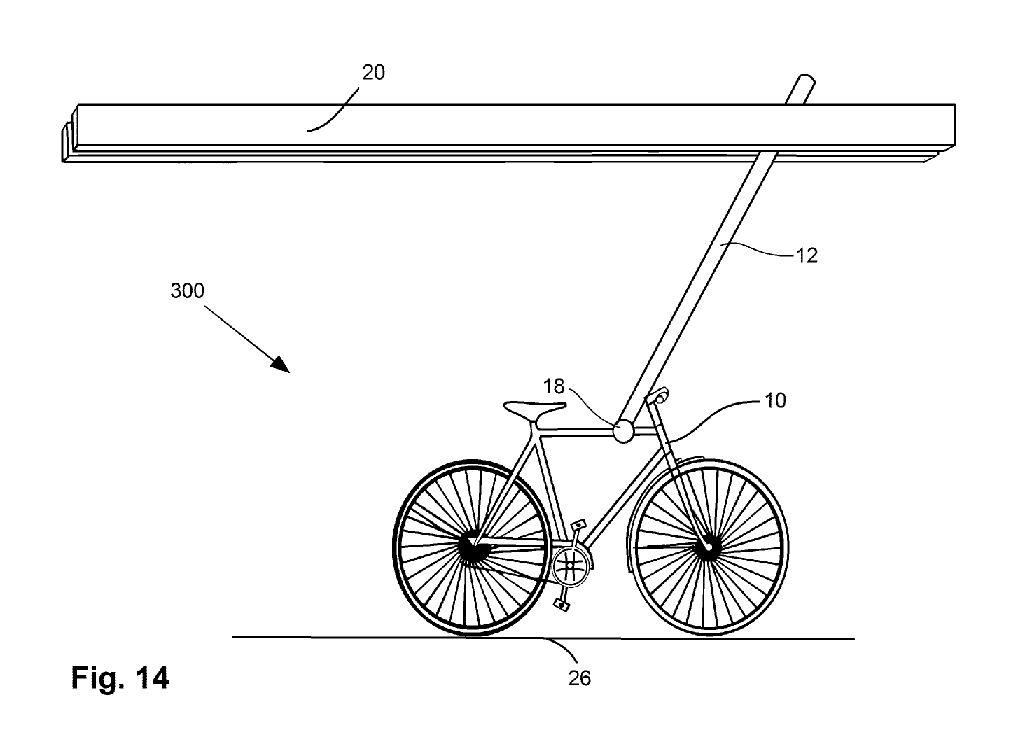

FIG. 12 is a perspective zoomed view on the guided device, which comprises a removable coating 30.

As in the first embodiment 100 of the invention, removable coating 30 may be used for decreasing the tilt and deviation limit of the bicycle of the trainee.

It should be noted that the single rail can be replaced by a taut cable.

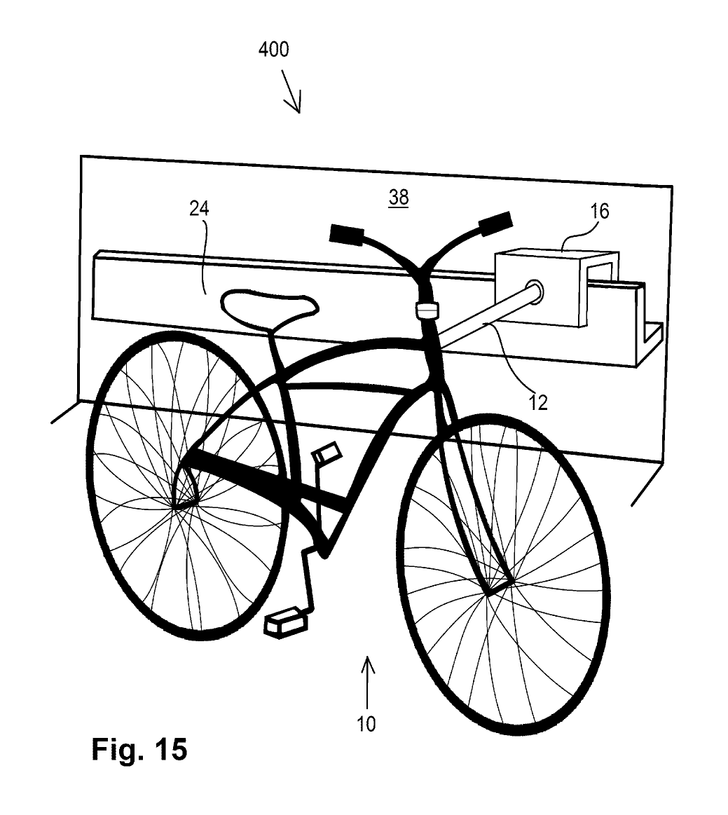

FIG. 13 is a front view of the system according to another configuration of this embodiment.

According to this configuration, pillars 22 are replaced by a supporting facility 40, which is attached to a wall 38.

### Third Embodiment of the Invention

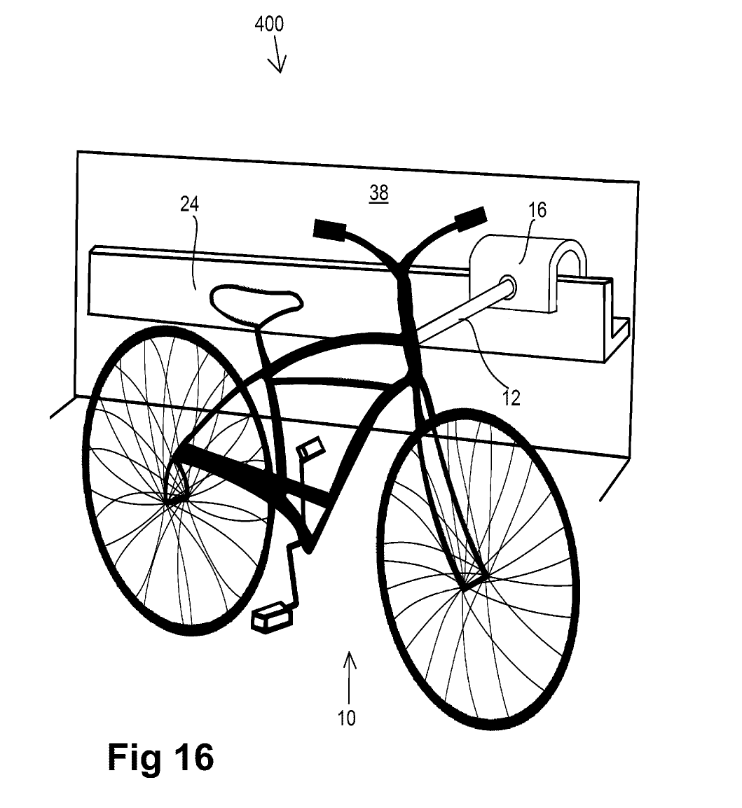

FIG. 14 schematically illustrates a cycling practicing system, according to a third embodiment (300) of the invention.

According to this embodiment of the invention, the stabilizer is the bare pole 12. In other words, the guided device is decreased to the size of pole 12, which limits the tilt; but not the deviation of the bicycle.

It should be noted that if pole 12 is inclined (turns forward or backward), it also limits the deviation. The inclination is illustrated in FIG. 7.

This embodiment of the invention may be suitable for an advanced stage of the practice.

### Fourth Embodiment of the Invention

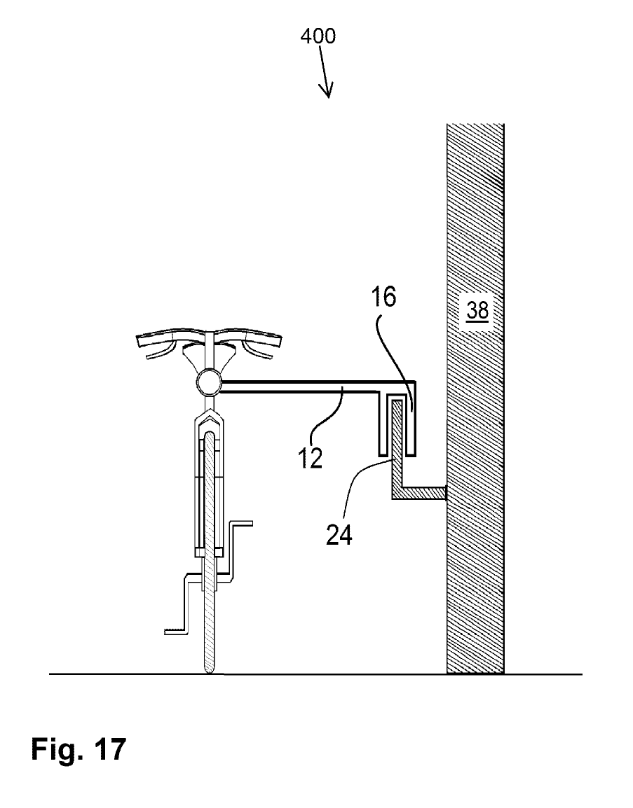

Each of FIGS. 15 and 16 schematically illustrate a cycling practicing system, according to a fourth embodiment (400) of the invention. FIG. 17 is a front-sectional view thereof.

According to this embodiments of the invention, the guided device 16 is has a rectangular open profile, while the guiding track 24 is in a form of a board.

This embodiment is like the second embodiment except of the location of the guiding track 24 which is disposed by the side of the bicycle 10.

It should be noted that in this figure the guiding track 24 is connected to a wall 38.

Since the guiding track 24 is placed by the side of the bicycle, the trainee can hold the guiding track when needed.

### Fifth Embodiment of the Invention

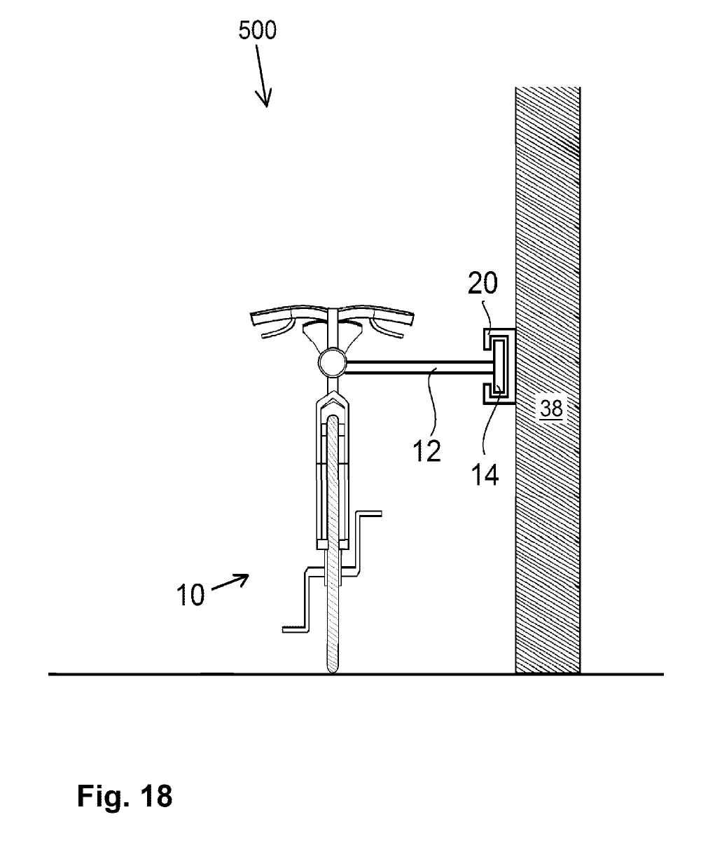

FIG. 18 is a front-sectional view which schematically illustrates a cycling practicing system, according to a fifth embodiment (500) of the invention.

According to one embodiment of the invention, the guiding track is in the form of a pair of parallel L rails (20), and the guided device is in the form of a board (14) disposed between the parallel rails (20). The board is firmly connected by the pole (12) to the bicycle (10).

According to a preferred embodiment of the invention, pole 12 which connects the guided device to bicycle 10 is detachable, rotatable and so on, in order to allow reversing the bicycle direction, and also adjusting the angle of the pole, in order to use an existing railings bar and so on as the single track 24.

In the figures and/or description herein, the following reference numerals (Reference Signs List) have been mentioned:
numeral 100 denotes a first embodiment of the invention;
numeral 200 denotes a second embodiment of the invention;
numeral 300 denotes a third embodiment of the invention;
numeral 400 denotes a fourth embodiment of the invention;
numeral 500 denotes a fifth embodiment of the invention;
numeral 10 denotes a bicycle of a trainee;
numeral 12 denotes a pole that firmly connects the guided device to bicycle 10;
numeral 14 denotes a board, as an example to a guided device;
numeral 16 denotes a profile, as an example to a guided device;
numeral 18 denotes an instant connector, for connecting pole 12 to bicycle 10;
numeral 20 denotes a pair of parallel rails;
numeral 22 denotes a pillar fixed to the ground, for supporting the guiding facility;
numeral 24 denotes a single rail, a taut cable, and so on;
numeral 26 denotes the ground, a floor, and so on;
numeral 28 denotes a bar connecting the pillars 22 to the single rail 24;
numeral 30 denotes a rigid or semi-rigid removable coating, for decreasing the space between the guiding track and the guided device;
numeral 32 denotes a cycling trainee;
numeral 34 denotes a bore in coating 30;
numeral 36 denotes a threaded bolt for securing coating 30 to the guided device;
numeral 38 denotes a wall; and
numeral 40 denotes a facility connected to a wall 38 for supporting a single rail, a pair of rails, a taut cable, and so on.

In the description herein, the following reference has been mentioned: U.S. Pat. No. 5,577,750

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A cycling practicing system, comprising:
a guiding facility, comprising:
a guiding track (20) fixed to the ground (26) or to a wall (38); and
an elongated guided device (14), firmly connected via a pole (12) to a bicycle (10) of said trainee and adapted to allow horizontal deviation of approximately 3 degrees;
wherein said guided device and said guiding track are loosely interlaced in each other and adapted to allow a vertical tilt of approximately 3 degrees;
thereby providing stability for riding said bicycle and preventing it from falling down.

2. A system according to claim 1, wherein:
said guiding track is in the form of a pair of parallel rails (20); and
said guided device is in the form of a board (14) disposed between said parallel rails (20), said board being firmly connected by said pole (12) to said bicycle (10).

3. A system according to claim 2, wherein a length of said board (14) is at least 10 cm.

4. A system according to claim 2, wherein a width of said board (14) is at least 10 cm.

5. A system according to claim 1, wherein:
said guiding track is in the form of a single rail or taut cable (24); and
said guided device is in the form of a profile surrounding rail or taut cable (24), and firmly connected by said pole (12) to said bicycle (10).

6. A system according to claim 5, wherein said profile is selected from a group consisting of: U profile, V profile, O profile, a square profile, a rectangular profile, two parallel boards.

7. A system according to claim 5, wherein a length of said profile (16) is at least 10 cm.

8. A system according to claim 5, wherein a width of said profile (16) is at least 10 cm.

9. A system according to claim 1, wherein said guided device is in an inclined pole (12) form.

10. A system according to claim 1, wherein said guided device further comprises a rigid or semi-rigid removable coating (30), for decreasing a space between said guided device and said guiding track, thereby increasing a limit of a tilt and deviation of said bicycle (10) with regard to said guiding track.

11. A system according to claim 10, wherein a thickness of said removable coating is at least 0.5 cm.

12. A system according to claim 1, wherein said pole (12) is connected to a steering bar of said bicycle (10).

13. A system according to claim 1, wherein said pole (12) is connected to a bar connecting a seat of said bicycle with a steering of said bicycle (10).

14. A system according to claim 1, wherein said pole (12) is connected to a back of said bicycle (10).

15. A system according to claim 1, wherein a space between said guided device and said guiding track is at least 2 cm.

16. A system according to claim 1, wherein said firmly connected is carried out by an instant connector (18).

17. A system according to claim 1, wherein said guiding track (20, 24) being disposed above the head of a riding trainee (32).

18. A system according to claim 1, wherein said guiding track (20, 24) being disposed by a side of a said bicycle.

19. A system according to claim 1, wherein said pole (12) is adapted to allow reversing the bicycle direction or employing an existing railing bar, by a detachable joint, rotatable joint, spherical joint, and so on.
